(19) United States
(12) Patent Application Publication
(10) Pub. No.: US 2015/0166683 A1
(43) Pub. Date: Jun. 18, 2015

(54) PROCESS FOR WASHING SOLID CELLULOSIC BIOMASS MATERIAL

(71) Applicant: SHELL OIL COMPANY, Houston, TX (US)

(72) Inventors: Johannes Pieter HAAN, Amsterdam (NL); Wouter SPIERING, Amsterdam (NL)

(21) Appl. No.: 14/574,703

(22) Filed: Dec. 18, 2014

(30) Foreign Application Priority Data
Dec. 18, 2013 (EP) 13197950.2

(51) Int. Cl. C08B 15/00

(52) U.S. Cl. CPC C08B 15/00

(57) ABSTRACT

A process for treating a solid cellulosic biomass material for reduction of the content of unwanted inorganic components prior to using the material in the production of a biofuel and/or biochemical, comprising:

providing a solid cellulosic biomass material;

washing the solid cellulosic biomass material with a stream of water or in a water bath, wherein the water has a temperature in the range from 120° C. to equal to or less than 150° C. at a pressure high enough to maintain water in the liquid phase, to provide washed cellulosic biomass material comprising significantly reduced levels of unwanted inorganic components when compared to the levels in the starting biomass material.

The present application claims the benefit of European Patent Application No. 1319750.2, filed Dec. 18, 2013, the entire disclosure of which is hereby incorporated by reference.

### TECHNICAL FIELD OF THE INVENTION

The present invention relates to a process for washing a solid cellulosic biomass material.

### BACKGROUND OF THE INVENTION

With the diminishing supply of crude petroleum oil, use of sustainable, annually renewable biomass material is becoming increasingly important for the production of liquid fuels and/or chemicals. The use of such annually renewable biomass material may also allow for a more sustainable production of liquid fuels and more sustainable CO₂ emissions that may help meet global CO₂ emissions standards under the Kyoto protocol.

Deriving liquid fuels and/or chemicals wholly or partly from non-edible solid biomass materials, such as cellulosic materials, is preferred as such non-edible solid biomass materials do not compete with food production.

Most of such non-edible solid biomass materials, however, comprise high concentrations of, possibly dissociated, mineral salts. The mineral salts or mineral ions may include alkaline metals such as potassium and/or sodium; alkaline earth metals such as magnesium and/or calcium; nitrogen, phosphorous, chlorine and/or sulphur.

These mineral salts and/or mineral ions may have a significant impact on processing equipment in a refinery. They may for example cause the formation of deposits, slags and fouling. In its dissolved form it may cause corrosion. When the salts precipitate during processing or co-processing in a refinery, they may form deposits in pipelines and equipment. The later may cause plugging and/or increased and/or unscheduled maintenance stops. In addition, where the mineral salts and/or mineral ions include any metal salts and/or metal ions, the salts and/or ions may poison one or more catalysts used in one or more of the refinery processes.

The salts and/or ions may be removed from cellulosic materials by washing and/or leaching.

It is also possible to first pretreat or liquefy a cellulosic material, whereafter salts and/or ions may be removed from the obtained pretreated cellulosic material or liquefied material by washing, leaching and/or extraction.

For example, NL1029909 describes a method for the treatment of biomass, wherein (wet) biomass is supplied to a torrefaction reactor and is torrefied in the torrefaction reactor by heating of the biomass to a torrefaction temperature of 200° C. to 320° C. in an oxygen-depleted environment under such a pressure that liquid water is present in the torrefaction reactor. NL1029909 describes that undesirable salts may dissolve in this liquid water during torrefaction and that such dissolved salts may subsequently be removed with the liquid water during a “sweating out” step after torrefaction.

In the report titled “Torwash, Proof of Principle—Phase 1” by J. R. Pels and P. C. A. Bergman, published by ECN Biomass, Coal and Environmental Research in 2006 as report no. ECN-E-06-021, the so-called TORWASH concept is described to be a thermic treatment of biomass in liquid water at temperatures in the range from 150° -300° C. Experiments were included where threshed hay was treated at temperatures ranging between 150 and 230° C. It was indicated that for threshed hay, the optimal temperature was 190-200° C. and that under those conditions about 30% of mass was dissolved and about 85% of the energy remained in the residue.

U.S.2003/0000661 describes processes and systems for treatment of wood chips prior to cooking in a pulp manufacturing process. In the process, water-soluble compounds are removed from the wood chips, especially for example compounds which disassociate in water to form potassium and/or chloride ions and/or water-soluble metal compounds such as manganese, calcium and potassium. It is described that in one embodiment the wood chips may be treated prior to cooking by bringing them into contact with an aqueous treatment stream such as water or a steam condensate at a temperature between 20° C. and 120° C. so as to reduce the water-soluble compounds.

U.S. Pat. No. 7,303,649 describe a process for the reduction of the concentration of undesirable inorganic elements present in wood chips prior to cooking in a production line for chemical pulp. The wood chips, having entrapped air, are treated with an aqueous leaching liquor at elevated temperature (40-120° C.) and pressure, followed by draining at atmospheric pressure or below atmospheric pressure, the pressures being controlled to yield a moisture content in the wood chips as low as possible for adequate leaching result and behaviour of the chips in a subsequent digester.

### SUMMARY OF THE INVENTION

It would be an advancement in the art to provide a process that allows for leaching or washing of a solid cellulosic biomass material which process is economic and results in highly efficient removal of undesirable minerals, especially those containing chlorides, with acceptable carbon loss, and which process is useful as a pretreatment for the production of biofuels. When the washed biomass will be used as a feed (to be co-prossessed with other refinery streams) in refineries, it was found to be particularly relevant to reduce chloride content to levels down to preferably below 20% of the starting chloride content.

Accordingly, the present invention provides a process for treating a solid cellulosic biomass material for reduction of the content of unwanted inorganic components prior to using the material in the production of a biofuel and/or biochemical, comprising:

(a) providing a solid cellulosic biomass material; and
(b) washing said solid cellulosic biomass material with a stream of water or in a water bath, wherein the water has a temperature in the range from 120° C. to equal to or less than 150° C. at a pressure high enough to maintain water in the liquid phase, to provide washed cellulosic biomass material comprising significantly reduced levels of unwanted inorganic components when compared to the levels in the starting biomass material(also referred to as the washing step).

The process according to the invention advantageously results in a high degree of mineral salt and/or mineral ion removal whilst carbon loss is kept at acceptable levels (i.e.

below 15%, preferably below 10%.

### BRIEF DESCRIPTION OF THE DRAWING

This drawing illustrates certain aspects of some of the embodiments of the invention, and should not be used to limit or define the invention.

FIG. 1 is a schematic illustration of an embodiment for a washing unit that can be used according to the invention process.

### DETAILED DESCRIPTION OF THE INVENTION

By a biomass material is herein understood a composition of matter of biological origin as opposed to a composition of matter obtained or derived from petroleum, natural gas or coal. Without wishing to be bound by any kind of theory it is believed that such composition of matter of biological origin may contain carbon-14 isotope in an abundance of about 0.0000000001%, based on total moles of carbon.

By a solid biomass material is herein understood a biomass material that is at least partly in a solid state at a temperature of about 20° C. and a pressure of about 0.1 MPa.

In an embodiment of the invention, the solid cellulosic biomass material is wetted, i.e. soaked in water, at ambient temperature before the washing step. Preferably, the soaking is performed during at least 1 hour, more preferably at least 2 hours, in particular at least 3 hours, and especially at least 4 hours, preferably up to 36 hours, more preferably up to 24 hours, and especially up to 12 hours. Overnight soaking effectively may remove already at least 10%, preferably at least 20%, more preferably at least 40%, and particularly at least 50% of the chlorides present in the dry biomass.

The present invention provides a process for treating a solid cellulosic biomass material for reduction of the content of unwanted inorganic components, wherein the unwanted inorganic components are selected from the group consisting of aluminium, calcium, barium, sulphur, phosphorous, chlorine, potassium, sodium, manganese, cadmium, magnesium, iron, zinc, and combinations thereof, and in particular the unwanted inorganic components are selected from calcium, sulphur, phosphorous, chlorine, potassium, sodium, and magnesium and combinations thereof (in particular in the form of salts), and more particularly chlorine, potassium and sodium and combinations thereof, and especially chlorine (in the form of chlorides).

The solid cellulosic biomass material used according to the invention is a material containing or consisting of cellulosic and/or lignocellulosic material. By a cellulosic material is herein understood a material containing cellulose and optionally lignin. By a lignocellulosic material is herein understood a material containing cellulose and lignin. For use in the process of the invention, such cellulosic or lignocellulosic material may further comprise hemicellose. Hemicellullose is a so-called polysaccharide. In contrast to cellulose, which only contains glucose monomers, hemicellulose may be understood to comprise or consist of a mixture of one or more polysaccharides, each polysaccharide containing one or more C5-sugar monomers, pentoses.

Preferably the biomass material comprises or consists of a material that is not used for food production. Examples of solid biomass materials include aquatic plants and algae, agricultural waste and/or forestry waste and/or paper waste and/or plant material obtained from domestic waste. The solid biomass material contains or consists of a cellulosic or lignocellulosic material. Examples of cellulosic or lignocellulosic materials include for example agricultural wastes such as corn stover, soybean stover, corn cobs, rice straw, rice hulls, oat hulls, corn fibre, cereal straws such as wheat, barley, rye and oat straw, grasses, forestry products and/or forestry residues such as wood and wood-related materials such as sawdust and bark, waste paper, sugar processing residues such as bagasse and beet pulp, or mixtures thereof. Preferably the solid cellulosic biomass material comprises or consists of a cellulosic or lignocellulosic material selected from the group consisting of wood, sawdust, bark, straw, hay, grasses, bagasse, corn stover and/or mixtures thereof. More preferably the solid cellulosic biomass material comprises wood, for example as wood chips. The wood may include soft wood and/or hard wood. Soft wood is a particularly preferred biomass for use in the process of this invention.

The solid biomass material preferably has undergone a particle size reduction. In a preferred embodiment, the solid biomass material has undergone a particle size reduction and is essentially not dried at any deliberately elevated temperature, torrefied, steam exploded, densified and/or pelletized before washing process of the invention.

The particle size of the solid biomass material can be reduced in any manner known to the skilled person to be suitable for this purpose. Suitable methods for particle size reduction include chipping, crushing, grinding and/or milling. The particle size reduction may preferably be achieved by means of a ball mill, hammer mill, (knife) shredder, chipper, knife grid, or cutter.

Preferably the solid biomass material particles have a mean thickness in the range from equal to or more than 0.5 mm to equal to or less than 20 mm, preferably equal to or less than 10 mm, and most preferably equal around 3 mm. Suitably, the length of the solid biomass particles is for example equal to or more than 0.5 mm to equal to or less than 10 cm, preferably equal to or less than 7 cm, more preferably in the range between 2-4 cm. In particular, the length to thickness ratio is from 0.1-20, more preferably from 2-15.

In an embodiment the particle size reduction of the solid biomass material may be carried out whilst having the solid biomass material suspended in a liquid to improve processibility and/or avoid dusting. The liquid can advantageously be water. This allows one to combine a particle size reduction step as described above with the wash step of the process according to the invention. The solid biomass material may already contain water.

For example, the solid biomass material may comprise in the range from equal to or more than 10 wt % to equal to or less than 80 wt % water. If the solid biomass material has been stored before being submitted to the washing process, the water content of the solid biomass material may have dropped. In some cases therefore, the water content of the solid biomass material may lie in the range from equal to or more than 10 wt % to equal to or less than 50 wt %. When the water content of a solid biomass material lies in the range from equal to or more than 10 to equal to or less than 50 wt %, it may be desirable to treat the solid biomass material with steam to remove air from the pores and/or wet the pores allowing the washing water to access the pores more easily. Hence, when providing a solid cellulosic biomass material having a water content in the range from equal to or more than 10 wt % to equal to or less than 80 wt %, and drying such solid biomass material (for example during storage) to obtain a dried solid biomass material having a reduced water content (for example in the range from equal to or more than 10 wt % to equal to or less than 50 wt %), it may be advantageous to subsequently treat the dried solid biomass material with steam to obtain a steamed solid biomass material wherein the water content is higher again than the water content of the dried solid biomass material.

Thus, in an embodiment of the invention, when the solid cellulosic biomass starting material has an initial water content of 10 wt % to equal to or less than 50 wt %, the washing process is preceded by a steam pretreatment step.

Subsequently, the provided solid biomass material is washed with water according to the invention to provide a washed biomass material.

During the washing step, the solid biomass material itself may preferably have a temperature in the range from equal to or more than 5° C. to equal to or less than 80° C.

The water has a temperature in the range from 120° C. to equal to or less than 150° C. at a pressure high enough to maintain water in the liquid phase, the temperature being preferably in the range from equal to or more than 130° C. to equal to or less than 145° C., more preferably from equal to or more than 135° C. to equal to or less than 145° C., and in particular the temperature is 140° C. For the pressure, the person skilled in the art can use well known tables and diagrams to determine the correct pressure, for example the pressure at a temperature of 120° C. will have to be at least 0.19 MPa and at 140° C. at least 0.35 MPa.

At the start of the process, the water may already comprise one or more other components and/or contaminants. For example, the water may comprise one or more organic compounds and/or one or more, possibly dissolved, salts and/or ions. Examples of such one or more organic compounds include hydrocarbon compounds and/or oxygenates. Examples of such possible dissolved salts and/or ions include nitrogen (for example in the form of ammonia and/or amines), potassium, sodium, phosphorous, sulphur, magnesium, calcium, silicon and/or chlorides. Preferably, however, the water is relatively clean. Preferably the concentration of chlorides in the water is equal to or less than 150 ppm weight, more preferably equal to or less than 100 ppm weight, yet more preferably equal to or less than 50 ppm weight, even more preferably equal to or less than 20 ppm weight, and most preferably equal to or less than 10 ppm weight, based on the total weight of the water. Suitably, the concentration of chlorides in the water is equal to or more than 0 ppm weight of the water. Preferably the concentration of calcium, potassium and sodium in the water, each separately, is equal to or less than 150 ppm weight, more preferably equal to or less than 100 ppm weight, yet more preferably equal to or less than 50 ppm weight, even more preferably equal to or less than 20 ppm weight, and most preferably equal to or less than 10 ppm weight, based on the total weight of the water. Suitably, the concentration of calcium, potassium and sodium in the water, each separately, is equal to or more than 0 ppm weight of the water. Preferably, the concentration of sulphides in the water is equal to or less than 100 ppm weight, more preferably equal to or less than 50 ppm weight, yet more preferably equal to or less than 20 ppm weight, even more preferably equal to or less than 10 ppm weight, and most preferably equal to or less than 5 ppm weight, based on the total weight of the water. Suitably, the concentration of sulphides in the stream of water is equal to or more than 0 ppm weight of the water. Preferably, the concentration of cyanides in the water is equal to or less than 100 ppm weight, more preferably equal to or less than 30 ppm weight, yet more preferably equal to or less than 10 ppm weight, even more preferably equal to or less than 5 ppm weight, and most preferably equal to or less than 1 ppm weight, based on the total weight of the water. Suitably, the concentration of cyanides in the water is equal to or more than 0 ppm weight of the water. Preferably, the concentration of ammonia in the water is equal to or less than 500 ppm weight, more preferably equal to or less than 200 ppm weight, yet more preferably equal to or less than 100 ppm weight, even more preferably equal to or less than 70 ppm weight, and most preferably equal to or less than 50 ppm weight, based on the total weight of the water. Suitably, the concentration of ammonia in the water is equal to or more than 0 ppm weight of the water. In addition, the water may comprise traces of hydrocarbons. Most preferably, any contaminants in the water may be present only at a level below 1 ppm weight.

The water may for example contain or consist of fresh water; boiler feed water, condensed waste steam; water obtained from one or more distillation towers; wasted cooling water; recycled cleaned water; and/or recycled stripped sour water. Examples of fresh water include surface water (for example obtained from rivers and/or lakes in the neighbourhood of a refinery); purchased water (for example water purchased from a municipality, service- or tap-water); groundwater; rain or storm water. More preferably the water comprises or consists of fresh water and/or recycled stripped sour water.

The weight ratio of the water to the solid biomass material may preferably lie in the range of equal to or more 0.5:1 (kg water: kg dry feed), preferably equal to or less than 50:1, more preferably equal to or less than 10:1, most preferably equal to or less than 5:1.

The solid biomass material may be washed in any manner known to the person skilled in the art to be suitable therefore.

In one embodiment, the solid cellulosic biomass material may be washed via so-called immersion leaching. Immersion leaching is herein understood to refer to a method comprising the submerging the solid biomass material within water and submitting it to a batch or continuous flow of water. The immersion leaching may be carried out with or without agitation. The leaching time during such immersion leaching may preferably vary in the range from equal to or more than 5 minutes, preferably equal to or more than 10 minutes, more preferably equal to or more than 30 minutes, to equal to or less than 2 hours, preferably equal to or less than 1 hour.

In another embodiment, the solid cellulosic biomass material may be washed via so-called spray or pour leaching. By spray respectively pour leaching is herein understood the spraying respectively pouring of water onto a layer of solid biomass material. Preferably the layer of solid biomass material is supported on a porous surface, which porous surface allows the leachate water to drip through.

The washing may be carried out batchwise, continuously or semi-continuously. Preferably, the process of the invention is a continuous process.

Any equipment known to the skilled person in the art to be suitable for the washing of a solid biomass material may be used for the washing step.

In an embodiment the washing is carried out in a staged manner, where water is supplied to the solid cellulosic biomass material in two or more subsequent stages.

The solid cellulosic biomass material may be washed with a stream of water in a co-current, cross current or counter current manner. Preferably the solid biomass material is washed with a stream of water in a counter current manner. Counter current removal of soluble inorganic components from biomass materials can be accomplished in a variety of commercial equipment, for example as used in the food processing industry (by comparison, most stagewise washers used in the pulp industry are designed primarily for thorough washing of fibers and not necessarily for obtaining a high concentration of solutes in the wash water), such as screw conveyors (single or twin) and screw towers. Twin-screw conveyors provide better liquid/solid contact and, thus, are generally more efficient than single-screw conveyors. The particle size of the biomass material may be important in continuous counter current washing because very fine particles tend to compact and cause liquid to channel or block liquid flow completely. Preferably, in the process of the invention a continuous counter current screw conveyer is used relying on percolation of water by gravity through the biomass material. Further preferred, the conveyer tower of such a counter current screw conveyer is slightly tilted to allow an easy flow of the water. In another embodiment, the solid biomass material is washed in a so-called screw press and/or rotary drum washer. During washing the stream of water is preferably supplied in a counter current fashion to the solid biomass material.

After the washing step, a washed biomass material is obtained. The washed biomass material has a reduced content of mineral salts and/or ions, at acceptable mass loss. Preferably, the chloride content is reduced by at least 75%, more preferably by at least 80%, even more preferred by at least 85%, in particular by at least 90%, and especially by at least 95%.

The washed solid biomass material may subsequently undergo drying, torrefaction, steam explosion, (further) particle size reduction, densification and/or pelletization and may hence be converted into a dried, torrefied, steam exploded, densified and/or pelletized form.

The particle size of the washed solid biomass material can be (further) reduced in any manner known to the skilled person to be suitable for this purpose. Suitable methods for particle size reduction include crushing, grinding and/or milling. The particle size reduction may preferably be achieved by means of a ball mill, hammer mill, (knife) shredder, chipper, knife grid, or cutter.

In an embodiment, the washed solid biomass material is first dried and/or torrefied, before reducing its particle size. Preferably, the washed solid biomass material is dried and/or torrefied and subsequently micronized to obtain a micronized solid biomass material. Such a dried and/or torrefied and/or micronized solid biomass material may advantageously have an improved processibility downstream.

Preferably the micronized washed solid biomass material has a particle size distribution where the mean particle size lies in the range from equal to or more than 5 micrometer (micron), more preferably equal to or more than 10 micrometer, even more preferably equal to or more than 20 micrometer, and most preferably equal to or more than 100 micrometer to equal to or less than 5000 micrometer and most preferably equal to or less than 500 micrometer. Most preferably the solid washed biomass material has a particle size distribution where the mean particle size is equal to or more than 100 micrometer and/or equal to or less than 3000 micrometer to avoid blocking of pipelines and/or pumps.

For practical purposes the particle size distribution and mean particle size of the solid biomass material can be determined with a Laser Scattering Particle Size Distribution Analyzer, preferably a Horiba LA950, according to the ISO 13320 method titled, “Particle Size Analysis—Laser Diffraction Methods”.

The washed solid biomass material may conveniently be forwarded to one or more conversion units for conversion thereof. For example the washed solid biomass material may conveniently be forwarded to a fermentation unit, liquefaction unit, thermal cracking unit, a hydrocracking unit, resid cracking unit or a fluid catalytic cracking unit in a refinery. If so desired, the washed solid biomass material may suitably be mixed with a petroleum derived feed, and the two feeds may be forwarded to one or more conversion units in the refinery for simultaneous co-processing. Preferably such a petroleum derived feed comprises or consists of a fossil-derived material. Preferably the petroleum derived feed, respectively the fossil-derived material, comprises one or more hydrocarbon compounds. By a hydrocarbon compound is herein understood a compound consisting of hydrogen and carbon atoms. The petroleum derived feed, respectively the fossil-derived material, preferably contains or consists of a crude oil and/or a fraction thereof. For example the petroleum derived feed may comprise or consist of a straight gas oil, a vacuum gas oil (VGO), a coker gas oil, an atmospheric residue (long residue) and/or a vacuum residue (short residue) fraction.

The product of the one or more conversion units as mentioned above may be useful as a biofuel and/or biochemical component and may be mixed with one or more other components to provide a biofuel and/or biochemical.

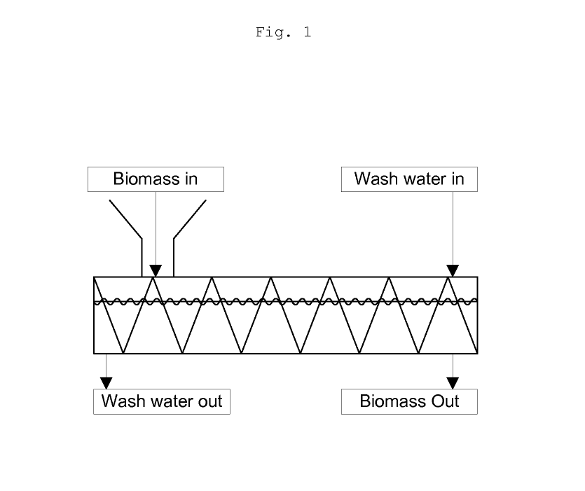

### Brief Description of FIG. 1

FIG. 1 depicts a conceptual scheme for a washing unit that can be used according to the invention. The Figure shows a screw conveyor system with a biomass inlet and outlet and a water inlet and outlet, in which a water stream and solid biomass material are introduced in a counter current manner.

The conveyor may also be slightly tilted (not shown), such that the water inlet is located higher than the biomass inlet.

### Legends to the Figures

FIG. 1. Screw conveyor counter current biomass washing unit.

The invention is illustrated by the following non-limiting examples.

### EXAMPLE

The feedstock for the washing tests of wood was virgin spruce and was chipped with a commercial type chipper. Chipper thickness was set at 3 mm. The chips were spread on a clean sheet and visually inspected to remove manually any oversized chips and impurities. The remaining material was sieved over a 1 mm sieve to remove fines.

Moisture content has been measured according to ASTM D4442. The chloride content of the solid wood was measured via combustion of the sample in a bomb followed by ion chromatography of the formed liquid. Chloride content of the wash liquids were directly measured by ion chromatography. The reported chloride contents of the washed wood chips were calculated from the original chloride content of the virgin wood and the chloride amount which had gone into in the wash water solution.

The virgin spruce had a moisture content of 65 % wt. and a chloride content of 148 mg/kg (on dry basis).

In all washing steps ultra pure water has been used at neutral pH. The water to wood (dry basis) ratio was 10 to 1 in all cases.

Prior to active washing the wood chips were overnight soaked in a polyethylene container (passive washing) at 20° C. After the soak the wood chips and water were separated. Subsequently the wood chips were submitted to a 2 times water wash in a stirred autoclave. This was done at different temperatures up to 160° C. The pressure of the autoclave was atmospheric for temperatures up to 100° C. or the resultant saturated water vapor pressure at the applied temperature.

After overnight soaking the chloride content of the wood was reduced to 61 mg/kg and indicates that the first 50-60% of the chlorides present be removed by a simple soaking treatment.

A water wash treatment at 20° C. after the soak resulted in a minor decrease of the chloride content of the wood chips. Increasing the temperature of the wash water (after the soak) up to 100° C. resulted in a further, but minor decrease of the chloride level. Only when raising the temperature of the wash water to 120° C. or above, a significant chloride removal was observed. An optimum wash water temperature was observed at 140° C. Above this temperature hemi-cellulose components in the wood chips start to dissolve in the wash water. This results in a concentrating effect on the remaining wood.

| | Wood chip | Cl | Carbon |
|---|---|---|---|
| | Cl content | removal | loss |
| | mg/kg (dry basis) | % | % wt |
| Virgin wood | 148 | Not | |
| | | applicable | |
| Overnight | 61 | 58.8 | |
| soak at 20° C. | | | |
| 2 × washing, | | | |
| ° C./MPa | | | |
| 20/0.101 | 51 | 65.5 | |
| 80/0.101 | 44 | 70.3 | |
| 100/0.101 | 40 | 73 | 0.8 |
| 120/0.199 | 17 | 88.5 | 3.6 |
| 140/0.361 | 6 | 95.9 | 9.1 |
| 160/0.618 | 24 | 83.8 | 25.1 |

We claim:

1. A process for treating a solid cellulosic biomass material for reduction of the content of unwanted inorganic components prior to using the material in the production of a biofuel and/or biochemical, comprising:
(a) providing a solid cellulosic biomass material; and
(b) washing said solid cellulosic biomass material with a stream of water or in a water bath, wherein the water has a temperature in the range from 120° C. to equal to or less than 150° C. at a pressure high enough to maintain water in the liquid phase;
thereby providing washed cellulosic biomass material comprising significantly reduced levels of unwanted inorganic components when compared to the levels in the starting biomass material.

2. The process of claim 1 wherein the solid cellulosic biomass material is wetted at ambient temperature before the washing step.

3. The process of claim 1 wherein the unwanted inorganic components are selected from the group consisting of aluminium, calcium, barium, sulphur, phosphorous, chlorine, potassium, sodium, manganese, cadmium, magnesium, iron, zinc, and combinations thereof.

4. The process of claim 3 wherein the unwanted inorganic components are selected from the group consisting of calcium, sulphur, phosphorous, chlorine, potassium, sodium, and magnesium and combinations thereof

5. The process of claim 4 wherein the unwanted inorganic components are selected from the group consisting of chlorine, potassium and sodium and combinations thereof.

6. The process of claim 5 wherein the unwanted inorganic components is chlorine.

7. The process of claim 1 wherein the process is a continuous process.

8. The process of claim 1 wherein the solid cellulosic biomass material is washed in a counter-current manner.

9. The process of claim 1 wherein the washing is carried out at a temperature in the range from equal to or more than 130° C. to equal to or less than 145° C.

10. The process of claim 9 wherein the washing is carried out at a temperature from equal to or more than 135° C. to equal to or less than 145° C.

11. The process of claim 10 wherein the washing is carried out at a temperature of about 140° C.

12. The process of claim 1 wherein the washing step is carried out in equal to or more than 5 minutes.

13. The process of claim 12 wherein the washing step is carried out in equal to or more than 10 minutes to equal to or less than 2 hours.

14. The process of claim 13 wherein the washing step is carried out in equal to or more than 30 minutes, to or less than 1 hour.

15. The process of claim 1 wherein weight ratio of the water used to the solid cellulosic material is equal to or more than 0.5:1.

16. The process of claim 15 wherein the weight ratio of the water used to the solid cellulosic material is equal to or less than 50:1.

17. The process of claim 16 wherein the weight ratio of the water used to the solid cellulosic material is equal to or less than 10:1.

18. The process of claim 17 wherein the weight ratio of the water used to the solid cellulosic material is equal to or less than 5:1.

19. The process of claim 1 wherein the solid cellulosic biomass is selected from wood, sawdust, bark, straw, hay, grasses, bagasse, corn stover and/or mixtures thereof, preferably wood, and especially soft wood.

20. The process of claim 1 wherein the solid cellulosic biomass is provided in particles having a mean thickness in the range from equal to or more than 0.5 mm to equal to or less than 20 mm.

21. The process of claim 20 wherein the solid cellulosic biomass is provided in particles having a mean thickness to equal to or less than 10 mm.

22. The process of claim 21 wherein the solid cellulosic biomass is provided in particles having a mean thickness to equal around 3 mm.

23. The process of claim 1 wherein the chloride content is reduced by at least 75%.

24. The process of claim 1 wherein the washed solid biomass material may subsequently undergo drying, torrefaction, steam explosion, particle size reduction, densification and/or pelletization.

25. The process of claim 1 wherein the washed solid biomass material is forwarded to a fermentation unit, liquefaction unit, thermal cracking unit, a hydrocracking unit, resid cracking unit and/or a fluid catalytic cracking unit in a refinery.

26. The process of claim 1 wherein the washed solid biomass material is co-processed with a petroleum derived feed, in one or more conversion units in a refinery.

27. The process of claim 26 wherein the petroleum derived feed comprises a straight gas oil, a vacuum gas oil (VGO), a coker gas oil, an atmospheric residue (long residue) and/or a vacuum residue (short residue) fraction.

28. The process of claim 16 wherein a product of the one or more conversion units is mixed with one or more other components to provide a biofuel and/or biochemical.
